(19) United States
(12) Patent Application Publication
(10) Pub. No.: US 2012/0265956 A1
(43) Pub. Date: Oct. 18, 2012

(54) STORAGE SUBSYSTEM, DATA MIGRATION METHOD AND COMPUTER SYSTEM

(75) Inventors: Koh Nakamichi, Kawasaki (JP); Yasunori Kaneda, Yokohama (JP); Akihisa Nagami, Yokohama (JP)

(73) Assignee: HITACHI, LTD., Tokyo (JP)

(21) Appl. No.: 13/127,493

(22) PCT Filed: Apr. 18, 2011
(86) PCT No.: PCT/JP2011/002255

§ 371 Date: May 4, 2011

(51) Int. Cl. G06F 12/16

(52) U.S. Cl. 711/162; 711/E12.103

(57) ABSTRACT

It is provided a storage subsystem, comprising: a storage device which provides a volume for storing data; a processor which executes a program for controlling the storage subsystem; a memory which stores data used by the processor; and a port which is coupled to another storage subsystem. The memory stores interface management information, which holds a use of the port in migration, and port management information, which holds a use of a port of the another storage subsystem in migration. The processor refers to the interface management information and the port management information to identify a port of the another storage subsystem which is permitted to communicate with the port of the storage subsystem, in order to determine a communication zone of the port coupled to the another storage subsystem for migration.

### TECHNICAL FIELD

This invention relates to a storage subsystem, and more particularly, to a method of referring to volumes from a destination storage subsystem in the migration of a volume between storage subsystems.

### BACKGROUND ART

In a computer system that includes a plurality of storage subsystems, the resource utilization ratio sometimes unintentionally becomes unbalanced among the storage subsystems. The unbalance can be solved by a technology of executing the migration of logical volumes between storage subsystems. Desirably, the influence of volume migration between storage subsystems over a host is made as small as possible. In other words, it is ideal if a volume can be migrated between storage subsystems securely without stopping applications that are running on a host.

As this type of prior art, JP 2008-176627 A discloses a technology with which data is migrated from a source storage subsystem to a destination storage subsystem without suspending the access of a host computer to the data, and the host computer can continue to use the data relocated by the migration.

JP 2005-011277 A discloses an external connection storage technology with which a storage subsystem is coupled to an external storage subsystem, which is another storage subsystem having a storage area, and provides a storage area within the other storage subsystem to a host computer as a virtual storage area of its own storage subsystem.

### SUMMARY OF INVENTION

### Technical Problem

In a computer system where a plurality of storage subsystems are coupled in a manner that allows data communication with one another, when a conventional method is used in the migration of a logical volume between storage subsystems to connect the source volume to a migration port, the source volume can be recognized at every port that can communicate with this port. If a plurality of logical volumes are connected to a migration port in this state in order to, for example, concurrently execute the migration of the plurality of volumes to different storage subsystems, ports of the destination storage subsystems recognize both volumes that are to be migrated to their own storage subsystems and volumes that are to be migrated to the other storage subsystems than their own.

Specifically, as illustrated in FIG. 26, when a source storage subsystem equipped with logical volumes V01, V02, and V03 connects the logical volumes V01 and V03 to a migration port, ports coupled to the migration port via a volume migration network can recognize the logical volumes V01 and V03 of the source storage subsystem.

Volume migration types include, at least, “external connection” and “copy”. “External connection” allows a destination storage subsystem to use a storage area of a source storage subsystem as a storage area of the destination storage subsystem. “Copy” involves writing data of a storage area of a source storage subsystem to a volume of a destination storage subsystem. As illustrated in FIG. 26, a destination storage subsystem can therefore recognize migration volumes (i.e., the external connection-type volume V02 and the copy-type volumes V01 and V03) irrespective of the type of volume migration.

Consequently, an administrator selecting from among volumes that are recognized by a destination storage subsystem may choose as a source volume a volume that is to be migrated to another storage subsystem. Choosing a wrong source volume has a possibility of causing a serious failure in the running of the computer system.

Thus, there are at least three risks when the administrator executes volume migration processing. The first risk is erroneously choosing for a destination storage subsystem a volume that is to be migrated to another storage subsystem from among a list of volumes recognized at a port of the destination storage subsystem. The second risk is executing a wrong operation (e.g., copying when it is external connection that should be executed) for a volume that is chosen from among a list of volumes recognized at a port of a destination storage subsystem. The third risk is executing a wrong operation for a wrong volume.

### Solution to Problem

A representative aspect of this invention is as follows. That is, there is provided a storage subsystem, including: a storage device which provides a volume for storing data; a processor which executes a program for controlling an operation of the storage subsystem; a memory which stores data used by the processor; and a port which is connected coupled to another storage subsystem. The memory stores interface management information, which holds a use of the port in migration, and port management information, which holds a use of a port of the another storage subsystem in migration. The processor is configured to refers to the interface management information and the port management information to identify which a port of the another storage subsystem which is permitted to communicate with the port of the storage subsystem, thereby determining a communication zone of the port connected coupled to the another storage subsystem for migration.

### Advantageous Effects of Invention

According to the representative aspect of this invention, a destination storage subsystem is allowed to recognize only volumes that the destination storage subsystem can acquire.

### BRIEF DESCRIPTION OF DRAWINGS

FIG. 1 is a block diagram illustrating the configuration of a computer system according to the first embodiment.

FIG. 2 is a block diagram illustrating the physical configuration and program configuration of the storage subsystems according to the first embodiment.

FIG. 3 is a block diagram illustrating the physical configuration and program configuration of the host computers according to the first embodiment.

FIG. 4 is a block diagram illustrating the physical configuration and program configuration of the management computer according to the first embodiment.

FIG. 5 is a block diagram illustrating the physical configuration and program configuration of the switch device according to the first embodiment.

FIG. 6 is a diagram illustrating an example of the configuration of the communication I/F management table according to the first embodiment.

FIG. 7 is a diagram illustrating an example of the configuration of the recognized port management table according to the first embodiment.

FIG. 8 is a diagram illustrating an example of the configuration of the communication permission/prohibition management table according to the first embodiment.

FIG. 9 is a diagram illustrating an example of the configuration of the volume management table according to the first embodiment.

FIG. 10 is a diagram illustrating an example of the configuration of the acquired volume management table according to the first embodiment.

FIG. 11 is a diagram illustrating an example of the configuration of the zone management table according to the first embodiment.

FIG. 12 is a flow chart of volume migration management processing according to the first embodiment.

FIG. 13 is a flow chart illustrating details of the processing of setting a communication-permitted group to ports (S102) according to the first embodiment.

FIG. 14 is a flow chart illustrating details of the processing of allocating a source volume to a communication-permitted group (S104) according to the first embodiment.

FIG. 15A is a sequence diagram illustrating details of the volume migration processing (S105) and corresponding processing of the destination storage subsystem according to the first embodiment.

FIG. 15B is a sequence diagram illustrating details of the volume migration processing and corresponding processing of the destination storage subsystem according to the first embodiment.

FIG. 16 is a block diagram illustrating the physical configuration and program configuration of the management computer according to the second embodiment.

FIG. 17 is a diagram illustrating an example of the configuration of the migration NW management table 413 according to the second embodiment.

FIG. 18 is a flow chart of zone setting processing according to the second embodiment.

FIG. 19 is a sequence diagram illustrating details of Step S502 of the zone setting processing and corresponding processing of the switch device according to the second embodiment.

FIG. 20 is a flow chart of volume migration management processing according to the second embodiment.

FIG. 21 is a sequence diagram illustrating details of Step S704 of the volume migration management processing and corresponding processing of the destination storage subsystem according to the second embodiment.

FIG. 22 is a flow chart of volume migration management processing according to the third embodiment.

FIG. 23 is a sequence diagram illustrating the access authorization status notifying processing (S902) and corresponding processing of the other storage subsystems than the source storage subsystem according to the third embodiment.

FIG. 24 is a flow chart of zone setting processing according to the fourth embodiment.

FIG. 25 is a sequence diagram illustrating Step S1102 of the zone setting processing and corresponding processing of the source storage subsystem, the destination storage subsystem, and the switch device according to the fourth embodiment.

FIG. 26 is a diagram explaining problems of this invention.

### DESCRIPTION OF EMBODIMENTS

Modes for carrying out this invention are described below with reference to the drawings. In the following description, a CPU or a processor executes a program read out of a memory or a storage device, to thereby install a function of a host computer 100, a storage subsystem 300, or a management computer 400.

### First Embodiment

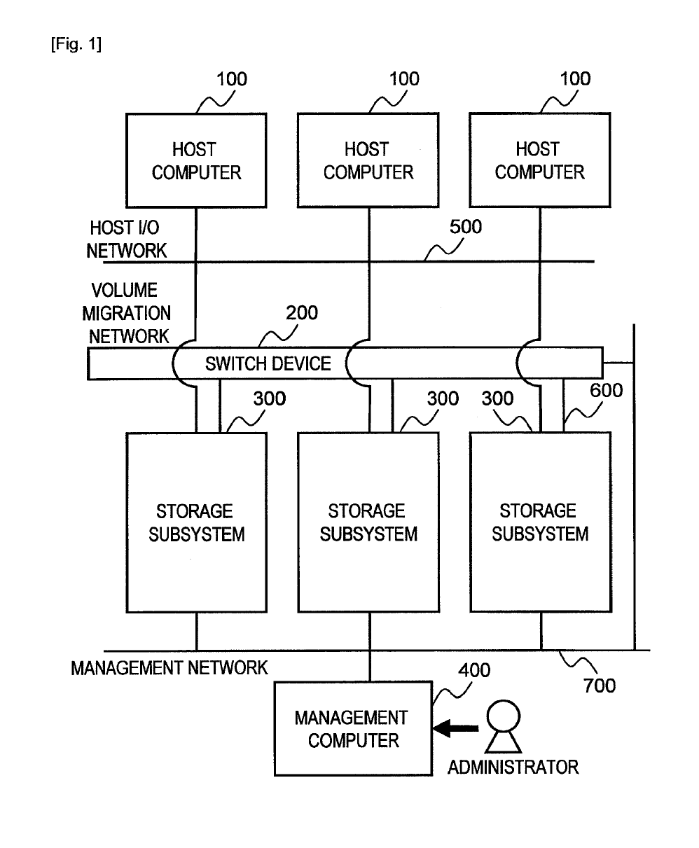

A first embodiment of this invention is described with reference to FIGS. 1 to 15.

A main feature of the first embodiment is that storage subsystems permitted to access a port of a source storage subsystem from which a volume is migrated are limited, with the type of migration managed on a source volume basis, so that a destination storage subsystem recognizing a volume can determine that the destination storage subsystem is permitted to acquire the volume and can execute processing appropriate for the volume.

FIG. 1 is a block diagram illustrating the configuration of a computer system according to the first embodiment of this invention.

The computer system of the first embodiment includes a plurality of host computers 100, a plurality of storage subsystems 300, and a management computer 400.

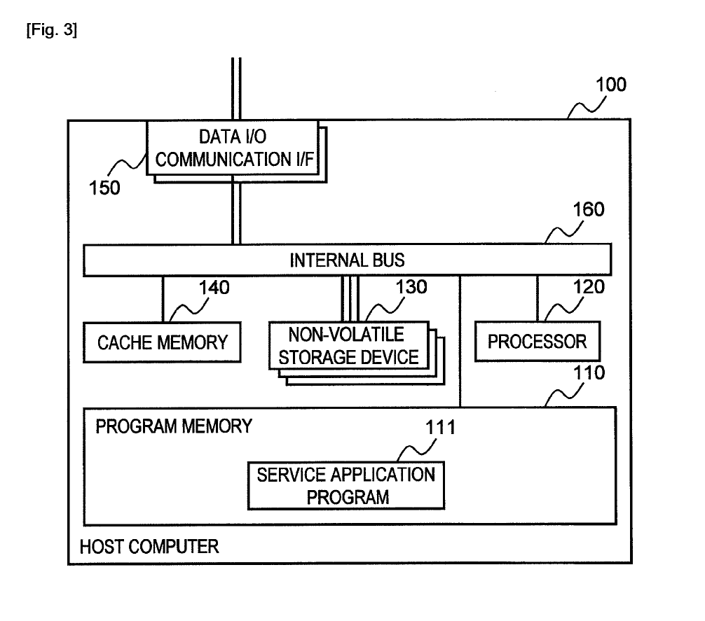

The host computers 100 are coupled to the storage subsystems 300 via a host I/O network 500 to issue a data write request and a data read request to the storage subsystems 300. The host I/O network 500 is a commonly available network such as a fibre channel network or an IP network. The host computers 100, the configuration of which is described later with reference to FIG. 3, can be general-purpose computers such as personal computers or servers.

The storage subsystems 300 are coupled to the host computers 100 via the host I/O network 500, and are coupled to one another via a volume migration network 600. The storage subsystems 300 can exchange data held in the storage subsystems 300 and management information with one another over the volume migration network 600.

The volume migration network 600 couples the storage subsystems 300 to one another via a switch device 200. The volume migration network 600 is a commonly available network such as a fibre channel network or an IP network. The switch device 200 is a network device such as an FC switch.

The computer system of the first embodiment has the management computer 400 which manages data communication between the storage subsystems 300. The management computer 400 is coupled to the storage subsystems 300 via a management network 700. The management network 700 is a commonly available network such as an IP network. The management computer 400 exchanges management information concerning volume migration processing with the storage subsystems 300 and the switch device 200 over the management network 700.

The host I/O network 500, the volume migration network 600, and the management network 700, which are separate networks in the first embodiment, may be the same single network.

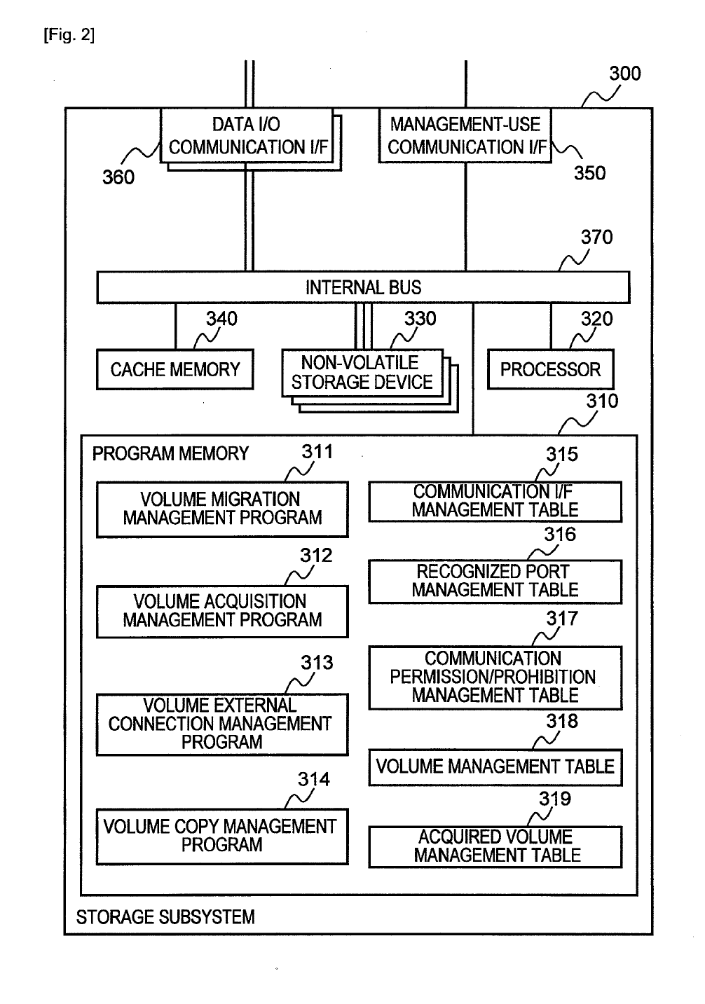

FIG. 2 is a block diagram illustrating the physical configuration and program configuration of the storage subsystems 300 according to the first embodiment.

Each of the storage subsystems 300 includes a program memory 310, a processor 320, a non-volatile storage device 330, a cache memory 340, a management-use communication I/F 350, and data I/O communication I/Fs 360. These components are connected to one another via an internal bus 370.

The storage subsystem 300 stores data written from one of the host computers 100 and data to be read to the host computer 200 in the non-volatile storage device 330. At least one of the data I/O communication I/Fs 360 is connected to the host I/O network 500 to be used for communication with the host computer 100. At least one of the data I/O communication I/Fs 360 is connected to the volume migration network 600 to be used for data transmission and reception between the storage subsystems 300.

The management-use communication I/F 350 is coupled to the management computer 400 via the management network 700.

The cache memory 340 is physically a commonly available semiconductor storage device and, similarly to a cache memory of a general-purpose computer, provides a storage area for temporarily storing data.

The non-volatile storage device 330 is constituted of, for example, at least one magnetic disk device (hard disk drive) and a semiconductor storage device that uses a non-volatile memory (solid state drive). A storage area of the non-volatile storage device 330 can be divided logically to be used as a plurality of data storage areas (logical volumes). The non-volatile storage device 330 may also group together a plurality of storage areas to be used as logically one data storage area (logical volume).

The program memory 310 is physically a storage device constituted of a magnetic disk device or a semiconductor storage device, and provides a storage area in which a program for putting the storage subsystem 300 into function and data are held. The processor 320 reads a program and data held in the program memory 310 and executes the program. The program memory 310 stores, at least, a volume migration management program 311, a volume acquisition management program 312, a volume external connection management program 313, a volume copy management program 314, a communication I/F management table 315, a recognized port management table 316, a communication permission/prohibition management table 317, a volume management table 318, and an acquired volume management table 319.

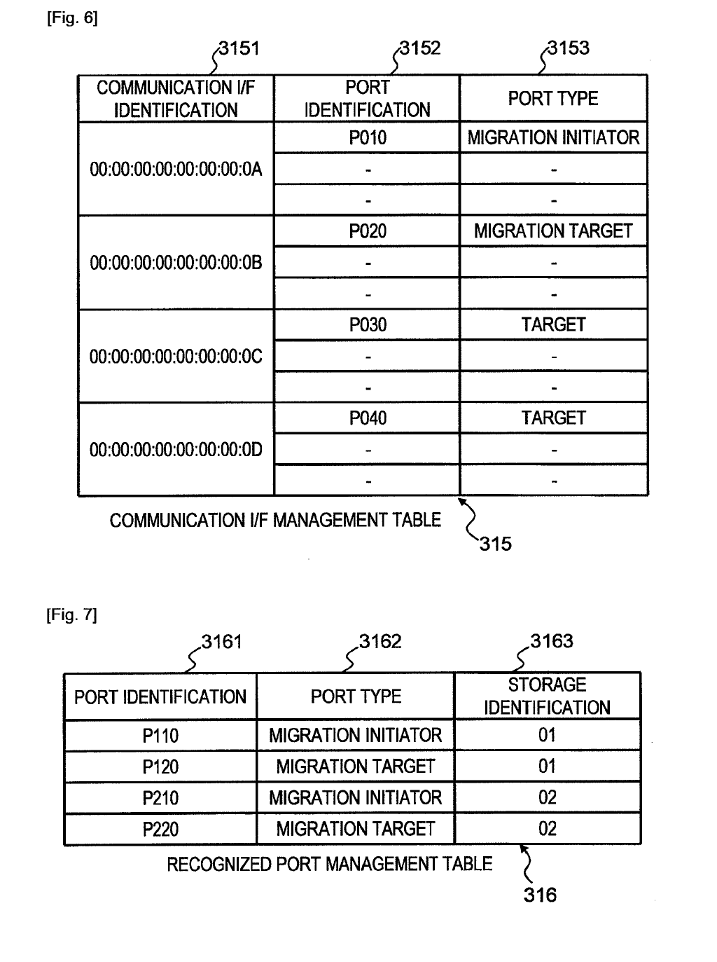

The programs held in the program memory 310 are described below. Details of the tables held in the program memory 310 are described later with reference to FIGS. 6 to 10. Various kinds of data in the description of the embodiments disclosed herein are in a table format, but may be configured to have other formats.

When a logical volume is migrated between the storage subsystems 300, the volume migration management program 311 in the storage subsystem 300 that contains the source volume sets settings relevant to migration processing, and updates the contents of various tables.

When a logical volume is migrated between the storage subsystems 300, the volume acquisition management program 312 in the storage subsystem that contains the destination logical volume sets settings relevant to migration processing, thereby enabling the volume external connection management program 313 and the volume copy management program 314 to utilize updated contents of various tables.

When a logical volume is migrated between the storage subsystems 300, the volume external connection program 313 executes processing of externally connecting a logical volume that is recognized by the storage subsystem 300 that contains the destination logical volume. Details of the external connection processing are disclosed in JP 2005-011277 A.

When a logical volume is migrated between the storage subsystems 300, the volume copy management program 314 copies data in a logical volume that is recognized by the storage subsystem 300 that contains the destination logical volume.

FIG. 3 is a block diagram illustrating the physical configuration and program configuration of the host computers 100 according to the first embodiment.

Each of the host computers 100 includes a program memory 110, a processor 120, a non-volatile storage device 130, a cache memory 140, and data I/O communication I/Fs 150. These components are connected to one another via an internal bus 160.

The data I/O communication I/Fs 150 are connected to the host I/O network 500 to be used for communication with one of the storage subsystems 300. The program memory 110 is physically a storage device constituted of a magnetic disk device or a semiconductor storage device, and stores a service application program 111. The processor 120 reads the service application program 111 out of the program memory 110 and executes the read program.

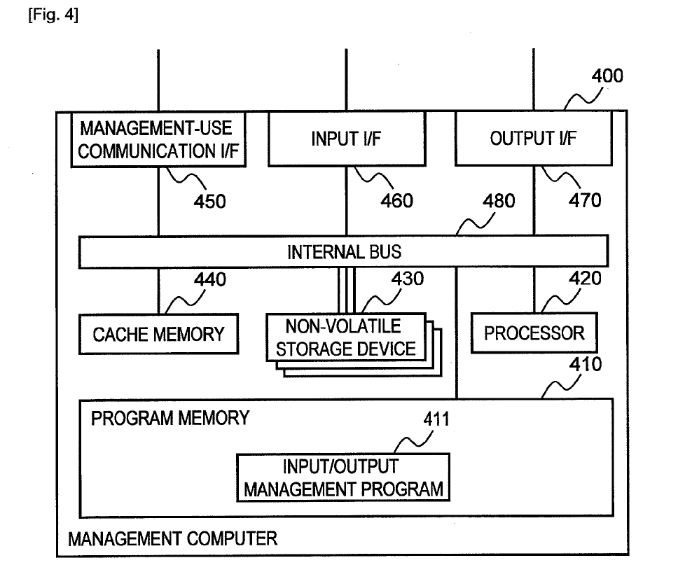

FIG. 4 is a block diagram illustrating the physical configuration and program configuration of the management computer 400 according to the first embodiment.

The management computer 400 includes a program memory 410, a processor 420, a non-volatile storage device 430, a cache memory 440, a management-use communication IF 450, an input I/F 460, and an output I/F 470. These components are connected to one another via an internal bus 480.

The management-use communication I/F 450 is connected to the management network 700 to be used for the exchange of settings relevant to volume migration and management information with the storage subsystems 300 and the switch device 200.

The input I/F 460 is an interface used by the administrator to input a command to the management computer 400 and is constituted of, for example, a mouse and a keyboard.

The output I/F 470 is an interface for outputting an execution result from the management computer 400 and is constituted of, for example, a display.

The program memory 410 is physically a storage device constituted of a magnetic disk device or a semiconductor storage device, and holds programs for controlling the operation of the management computer 400 and data used in the execution of these programs. The processor 420 reads a program out of the program memory 410 and executes the read program.

The program memory 410 holds, at least, an input/output management program 411. The input/output management program 411 transfers a volume migration instruction, which is input from the input I/F 460 by the administrator, to one of the storage subsystems 300, receives a processing result from the storage subsystem 300, and presents the processing result to the administrator through the output I/F 470.

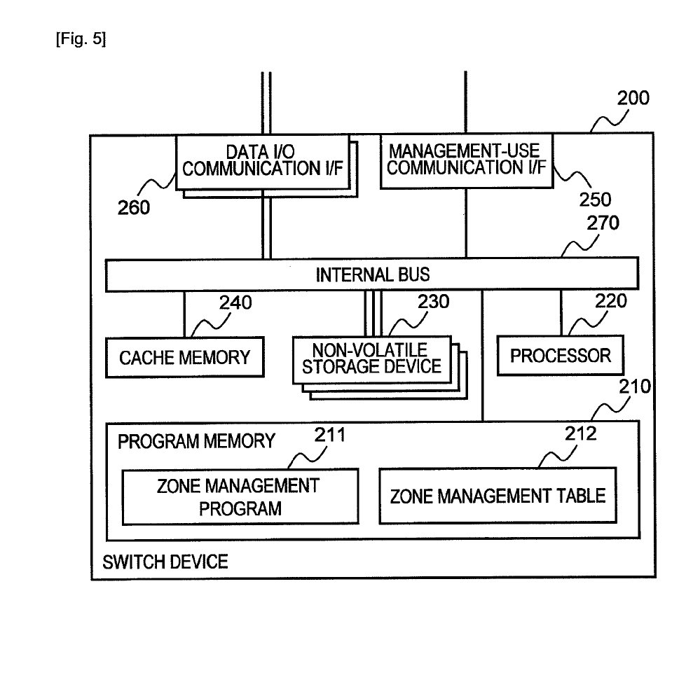

FIG. 5 is a block diagram illustrating the physical configuration and program configuration of the switch device 200 according to the first embodiment.

The switch device 200 includes a program memory 210, a processor 220, a non-volatile storage device 230, a cache memory 240, a management-use communication I/F 250, and data I/O communication I/Fs 260. These components are connected to one another via an internal bus 270.

The data I/O communication I/Fs 250 are connected to the volume migration network 600 to relay data transferred between the storage subsystems 300.

The management-use communication I/F 250 is connected to the management network 700 to be used for the exchange of settings relevant to volume migration and management information with the management computer 400.

The program memory 210 is physically a storage device constituted of a magnetic disk device or a semiconductor storage device, and holds programs for controlling the operation of the switch device 200 and data used in the execution of these programs. The processor 220 reads a program out of the program memory 210 and executes the read program.

The program memory 210 holds, at least, a zone management program 211 and a zone management table 212. The processor 220 reads a program out of the program memory 210 and executes the read program.

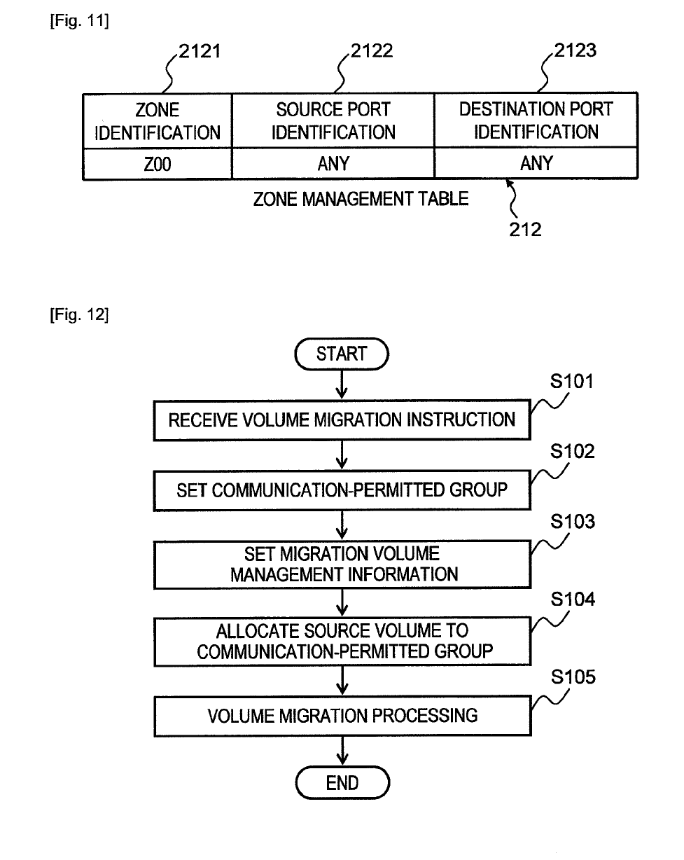

The zone management table 210 is a table used to manage access control of the switch device 200, and details thereof are described later with reference to FIG. 11.

FIG. 6 is a diagram illustrating an example of the configuration of the communication I/F management table 315 according to the first embodiment.

The communication I/F management table 315 is a table for managing the data 110 communication I/Fs 360 of the storage subsystem 300, and contains, at least, a communication I/F identification 3151, a port identification 3152, and a port type 3153 in each entry.

The communication I/F identification 3151 is an identification for uniquely identifying each data I/O communication I/F 360 of the storage subsystem 300. The communication I/F identification 3151 is, for example, a World Wide Name which is uniquely assigned to the hardware of a communication I/F in fibre channel.

The port identification 3152 is an identification for identifying a port that is allocated to a specific data I/O communication I/F 360 of the storage subsystem 300. The port identification 3152 is, for example, an N_Port_ID which is assigned dynamically to the hardware of a communication I/F in fibre channel. Although a plurality of port identifications 3152 may be defined for one physical data I/O communication I/F 360, the data I/O communication I/F identification 3151 and the port identification 3152 in the first embodiment are associated with each other on a one-on-one basis.

The port type 3153 is information for managing the use of a port. Ports of each storage subsystem 300 include, at least, a target which receives a command from the host, a migration initiator which issues a command to another storage subsystem 300, and a migration target which receives a command from another storage subsystem 300. A port that plays the role of a migration initiator issues a command to a port that serves as a migration target of the source storage subsystem 300. The terms “initiator” and “target” are defined in the SCSI standards.

FIG. 7 is a diagram illustrating an example of the configuration of the recognized port management table 316 according to the first embodiment.

The recognized port management table 316 is a table for managing ports that are recognized on the volume migration network 600 by the storage subsystem 300, and contains, at least, a port identification 3161, a port type 3162, and a storage identification 3163 in each entry.

The port identification 3161 is an identification for identifying a port that is recognized on the volume migration network 600 by the storage subsystem 300.

The port type 3162 indicates the type of a port that is recognized on the volume migration network 600 by the storage subsystem 300. The port type 3162 has the same value as the port type 3153 of the communication I/F management table 315. In other words, the migration of a logical volume is accomplished through communication between a migration target port of the source storage subsystem 300 and a migration initiator port of the destination storage subsystem 300.

The storage identification 3163 is the identification of the storage subsystem 300 that contains a port recognized on the volume migration network 600 by the storage subsystem 300. For each storage subsystem 300, the association relation between the storage subsystem 300 and a port may be set when the storage subsystem 300 is connected to the volume migration network 600 by, for example, an input from the administrator.

FIG. 8 is a diagram illustrating an example of the configuration of the communication permission/prohibition management table 317 according to the first embodiment.

The communication permission/prohibition management table 317 is a table for managing initiator ports that are permitted to communicate with a migration target port, and contains, at least, a communication-permitted group identification 3171, a port identification 3172, and a recognized port identification 3173 in each entry.

The communication-permitted group identification 3171 is an identification for identifying a group by which initiator ports permitted to communicate with a migration target port are managed. A communication-permitted group is set to a port of the storage subsystem 300 and a source logical volume is allocated to the communication-permitted group. When accessed by another storage subsystem 300, the port refers to the communication permission/prohibition table 317 to control access to the volume.

The port identification 3172 is the identification of a migration target port.

The recognized port identification 3173 is the identification of an initiator port that is recognized on the volume migration network 600 by the storage subsystem 300.

In this embodiment, a communication-permitted group is set that permits all ports to communicate with one another unless particularly specified in the communication permission/prohibition management table 317. Alternatively, only ports set in the communication permission/prohibition management table 317 may be permitted to communicate with one another.

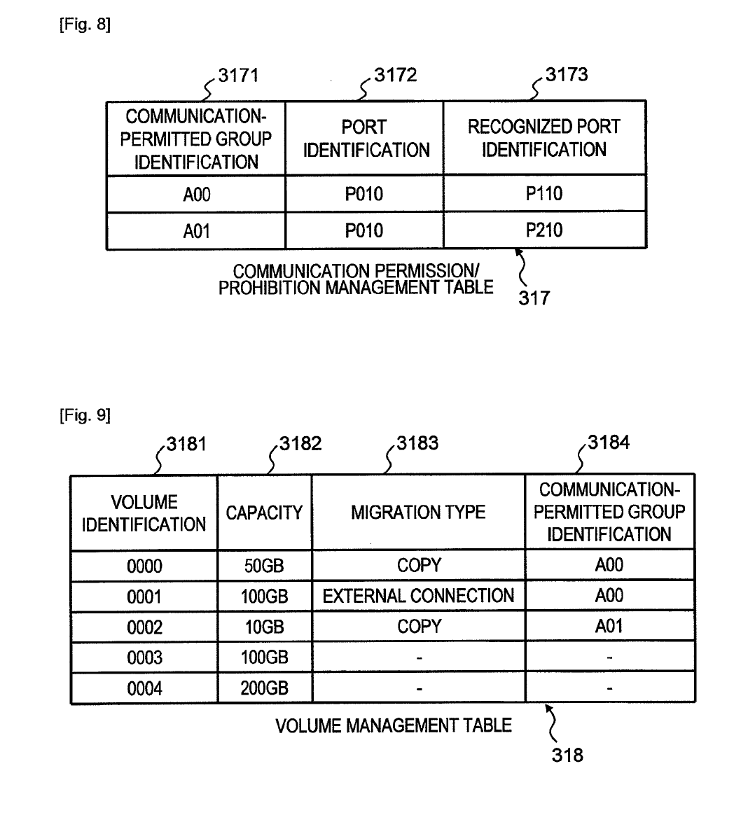

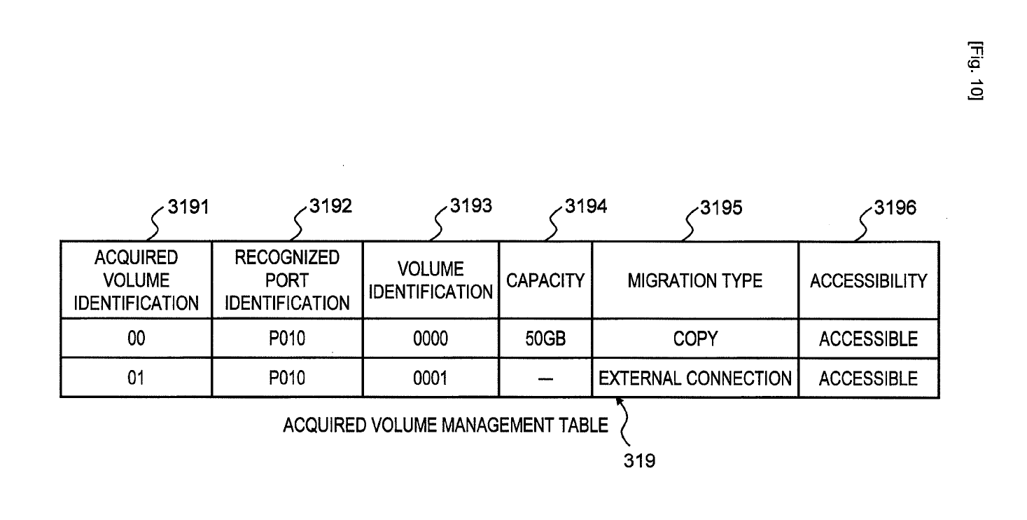

FIG. 9 is a diagram illustrating an example of the configuration of the volume management table 318 according to the first embodiment.

The volume management table 318 is a table for managing logical volumes that the storage subsystem 300 has, and contains, at least, a volume identification 3181, a capacity 3182, a migration type 3183, and a communication-permitted group identification 3184 in each entry.

The volume identification 3181 is a unique identification for identifying each logical volume that the storage subsystem 300 has.

The capacity 3182 is the storage capacity of a logical volume included in the storage subsystem 300.

The migration type 3183 indicates a type of volume migration which can be, for example, “external connection” for lending a storage area to another storage subsystem 300 or “copy” for copying the contents of a volume to a destination storage subsystem. The migration type 3183 is specified in a migration instruction given by the administrator at the time of volume migration, and no value is set as the migration type 3183 to a volume that is not instructed to migrate.

The communication-permitted group identification 3184 is the identification of a communication-permitted group that is allocated to connect a logical volume to the volume migration network 600 when the volume is migrated. The communication-permitted group identification 3184 is specified in a migration instruction given by the administrator at the time of volume migration, and no value is set as the communication-permitted group identification 3184 to a volume that is not instructed to migrate.

FIG. 10 is a diagram illustrating an example of the configuration of the acquired volume management table 319 according to the first embodiment.

The acquired volume management table 319 is a table for managing a volume that is recognized at a migration initiator port by the own storage subsystem 300, and contains, at least, an acquired volume identification 3191, a recognized port identification 3192, a volume identification 3193, a capacity 3194, a migration type 3195, and accessibility 3196 in each entry.

The acquired volume identification 3191 is a unique identification for identifying each source volume that is recognized by the destination storage subsystem 300.

The recognized port identification 3192 is the identification of a migration target port to which the recognized volume is connected.

The volume identification 3193 is the identification of the recognized volume that is used in the source storage subsystem 300. The destination storage subsystem 300 accesses the source volume based on the recognized port identification 3192 and the volume identification 3193.

The capacity 3194 is the storage capacity of the source volume.

The migration type 3195 indicates a type of migration for which the source volume is used. The migration type 3195 is information for identifying, for example, “external connection” in which the recognized volume lends a storage area or “copy” in which the contents of the volume are copied.

The accessibility 3196 is information that indicates an authorization status regarding access to the recognized logical volume. Access to the recognized volume is granted unless information that prohibits access is particularly recorded.

FIG. 11 is a diagram illustrating an example of the configuration of the zone management table 212 according to the first embodiment.

The zone management table 212 is a table for managing access control of the switch device 200. A zone is a concept in fibre channel that represents a group in which communications via the switch device 200 are grouped by WWN, port name, or the like, and access can be controlled by group. This embodiment uses port identifications to set a zone. A zone can be set by several other methods and the other zone setting methods may be employed in this invention. The zone management table 212 contains, at least, a zone identification 2121, a source port identification 2122, and a destination port identification 2123 in each entry.

The zone identification 2121 is a unique identification for identifying each zone. The source port identification 2122 is the identification of a source port. The destination port identification 2123 is the identification of a destination port.

In the zone management table 212 of FIG. 11, a zone is set in which two arbitrary ports are permitted to communicate with each other.

FIG. 12 is a flow chart of volume migration management processing according to the first embodiment. The volume migration management processing is executed by the processor 320 of the source storage subsystem 300 by executing the volume migration management program 311.

The processor 320 first receives a volume migration instruction from the input/output management program 411 of the management computer 400 (S101). When the volume migration instruction is input by the administrator, the input/output management program 411 of the management computer 400 transmits the migration instruction to the volume migration management program 311. The volume migration instruction received by the volume migration management program 311 contains, at least, the identification of a source logical volume, the identification of the destination storage subsystem 300, and a migration type.

The processor 320 next sets a communication-permitted group to ports to be used for communication between the received destination storage subsystem 300 and its own storage subsystem 300 (S102). Details of Step S102 are described later with reference to FIG. 13.

The processor 320 next sets the migration type 3183 of the logical volume specified by the management computer 400 in the volume management table 318 (S103).

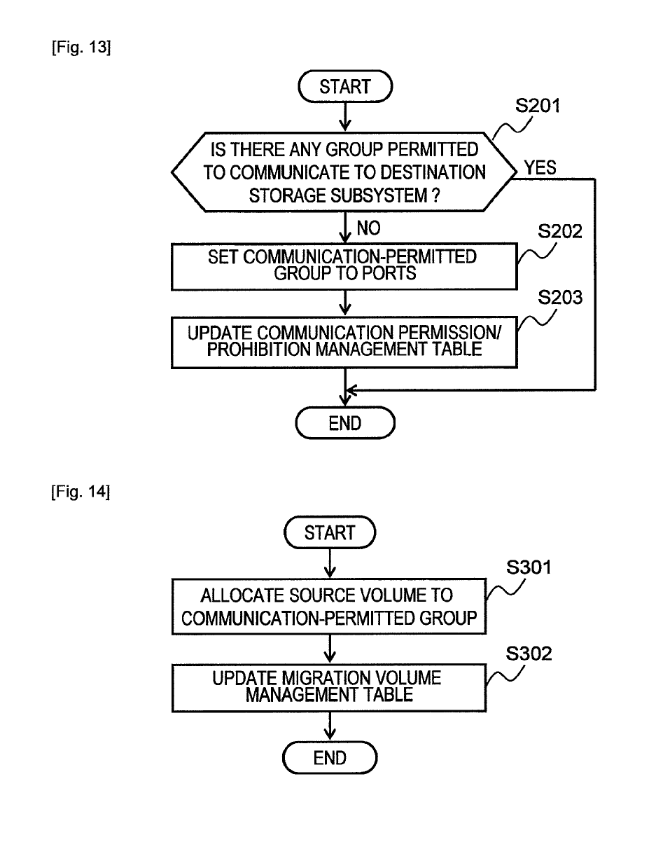

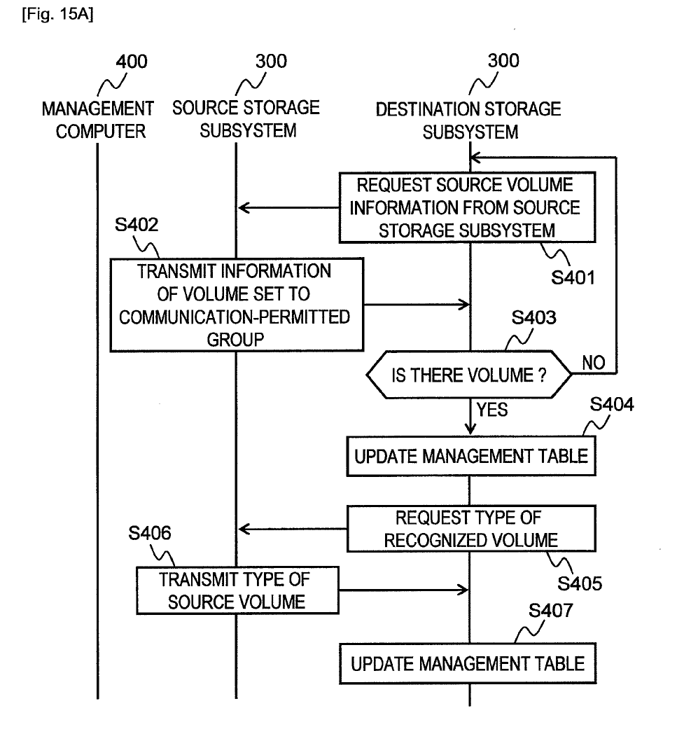

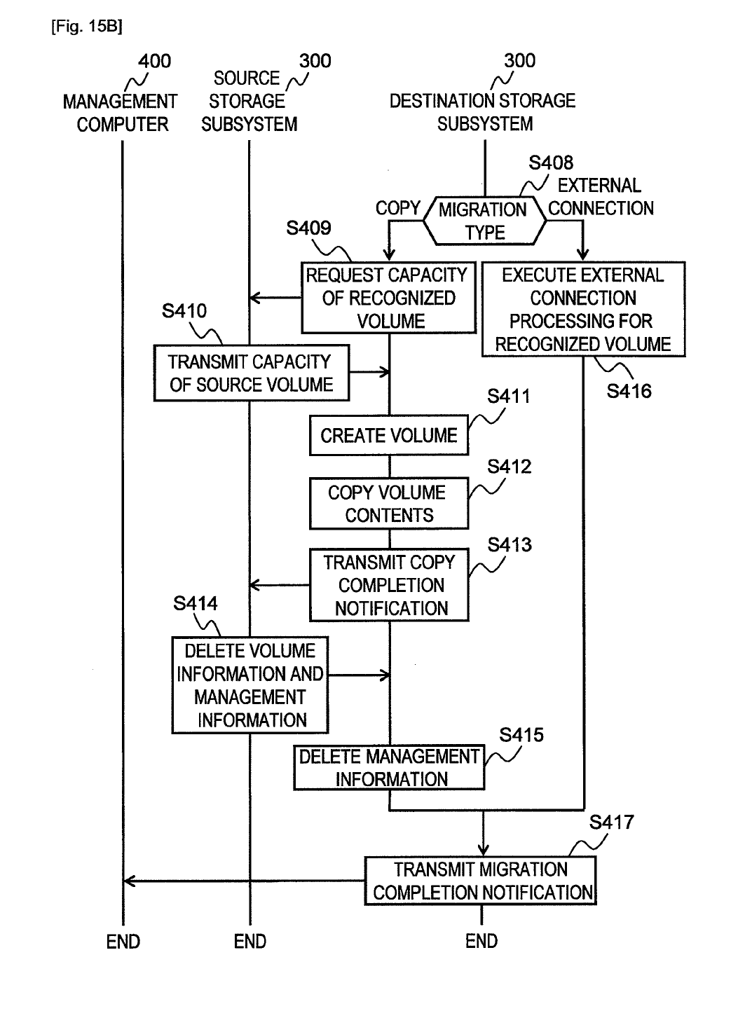

The processor 320 next allocates the logical volume specified by the management computer 400 to a communication-permitted group that is permitted to communicate with the destination storage subsystem 300, and sets the allocation in the volume management table 318 (S104). Details of Step S104 are described later with reference to FIG. 14.

The processor 320 then grants the destination storage subsystem 300 access and migrates the volume (S105). Details of Step S105 are described later with reference to FIGS. 15A and 15B.

FIG. 13 is a flow chart illustrating details of the processing of setting a communication-permitted group to ports (S102) according to the first embodiment.

The processor 320 first determines whether or not a communication-permitted group that is permitted to communicate with the destination storage subsystem 300 has already been set (S201). Specifically, the processor 320 determines that a communication-permitted group permitted to communicate with the destination storage subsystem 300 has already been set if the relevant port identification 3152 and port type 3153 of the communication I/F management table 315 are registered in the recognized port management table 316 and communication with a port identified by the port identification 3152 is not prohibited in the communication permission/prohibition management table 317. In the case where a communication-permitted group that is permitted to communicate with the destination storage subsystem 300 has already been set, there is no need to newly set a communication-permitted group, and the communication-permitted group setting processing is ended. In the case where a communication-permitted group that is permitted to communicate with the destination storage subsystem 300 has not been set, on the other hand, the processing proceeds to Step S202.

In Step S202, the processor 320 sets a communication-permitted group that is permitted to communicate with the destination storage subsystem 300 to ports (S202). Specifically, the processor 320 creates a pair of a port for which “migration target” is written as the port type 3153 in the communication I/F management table 315 and a port for which the identification of the destination storage subsystem 300 and “migration initiator” are written as the storage identification 3163 and the port type 3162, respectively, in the recognized port management table 316. The processor 320 sets a communication-permitted group to these ports.

The processor 320 then stores the communication-permitted group set in Step S202 in the communication permission/prohibition management table 317 (S203).

FIG. 14 is a flow chart illustrating details of the processing of allocating a source volume to a communication-permitted group (S104) according to the first embodiment.

The processor 320 allocates a source volume to a communication-permitted group (S301). Specifically, the logical volume specified by the management computer 400 is allocated to the communication-permitted group set in S102.

The processor 320 then updates the communication-permitted group identification 3184 of the volume management table 318 (S302).

FIGS. 15A and 15B are sequence diagrams illustrating details of the volume migration processing (S105) and corresponding processing of the destination storage subsystem according to the first embodiment. The sequence of FIGS. 15A and 15B is executed through the execution of the volume migration management program 311 by the processor 320 of the source storage subsystem and the execution of the volume acquisition management program 312 by the processor 320 of the destination storage subsystem.

The volume acquisition management program 312 periodically requests information of a source volume from the source storage subsystem (S401). Specifically, the processor 320 of the destination storage subsystem refers to the recognized port management table 316 and transmits an inquiry to a port whose port type 3162 is “migration target.”

The volume migration management program 311 transmits the identification of a volume permitted to communicate with the requester port to the destination storage subsystem (S402). Specifically, in response to the request from the volume acquisition management program 312 of the destination storage subsystem, the processor 320 of the source storage subsystem uses the identification of the requester port to search the communication permission/prohibition management table 317 and identify a communication-permitted group that includes this port identification. The processor 320 of the source storage subsystem then refers to the volume management table 318 to identify a logical volume that is associated with the identified communication-permitted group, and transmits information of the identified volume (a volume permitted to communicate with the requester port) to the destination storage subsystem. The volume information transmitted to the destination storage subsystem contains, at least, the identification of a port to which the source volume is connected and the identification of the source volume. In the case where the source volume is not found, information indicating “no volume” is transmitted to the destination storage subsystem.

The processor 320 (volume acquisition management program 312) of the destination storage subsystem determines the presence or absence of the source volume based on the information received from the source storage subsystem (S403). When information indicating “no volume” is received from the source storage subsystem, the processing returns to Step S401 and the processing is repeated. When information of the source volume is received from the source storage subsystem, on the other hand, the processing proceeds to Step S404.

In Step S404, the processor 320 (volume acquisition management program 312) stores the information received from the source storage subsystem as the recognized port identification 3192 and the volume identification 3193 in the acquired volume management table 319, and assigns the acquired volume identification 3191 (S404).

The processor 320 (volume acquisition management program 312) next refers to the accessibility 3196 of the acquired volume management table 319 and, when there is a volume to which access is permitted, requests the migration type of the recognized volume from the source storage subsystem (S405). The migration type request contains, at least, the recognized port identification 3192 and the volume identification 3193 that are retrieved from the acquired volume management table 319 as the identifications of a port and a volume that can be referred to.

Next, the processor 320 (volume migration management program 311) of the source storage subsystem refers to the volume management table 318 to transmit the migration type requested by the destination storage subsystem to the destination storage subsystem (S406).

The processor 320 (volume acquisition management program 312) of the destination storage subsystem stores the migration type received from the source storage subsystem as the migration type 3195 in the acquired volume management table 319 (S407).

The processor 320 (volume acquisition management program 312) of the destination storage subsystem refers to the migration type 3195 of the acquired volume management table 319 to identify the migration type (S408). When the migration type is “external connection,” the processor 320 (volume acquisition management program 312) of the destination storage subsystem transmits the acquired volume identification 3191 to the volume external connection management program 313, and the processing proceeds to Step S416. In Step S416, the volume external connection management program 314 executes external connection processing for a volume that is identified by the acquired volume identification 3191 received from the volume acquisition management program 312. At the time the external connection processing is finished, a notification of the completion of the processing is transmitted to the volume acquisition management program 312 (S416), and the processing proceeds to Step S417.

When the migration type is “copy,” on the other hand, the processor 320 (volume acquisition management program 312) of the destination storage subsystem transmits the acquired volume identification 3191 to the volume copy management program 314, and the processing proceeds to Step S409.

In Step 409, the processor 320 (volume copy management program 314) requests the capacity of the source volume from the source storage subsystem (S409). The capacity request contains, at least, the recognized port identification 3192 and the volume identification 3193 of the acquired volume management table 319.

The processor 320 (volume migration management program 311) of the source storage subsystem reads the capacity 3182 of the requested volume out of the volume management table 318, and transmits the requested volume capacity to the destination storage subsystem (S410).

The processor 320 (volume copy management program 314) of the destination storage subsystem stores the received volume capacity as the capacity 3194 in the acquired volume management table 319. The processor 320 then creates a logical volume that has the same capacity as the received volume capacity in the destination storage subsystem (S411).

The processor 320 (volume copy management program 314) of the destination storage subsystem next copies data stored in the source volume to the logical volume created in Step S411 (S412).

At the time the copying is finished, the processor 320 (volume copy management program 314) of the destination storage subsystem notifies the source storage subsystem of the completion of the copying. The copy completion notification contains the recognized port identification 3192, the volume identification 3193, and information about the number of acquired volumes (S413).

Receiving the copy completion notification from the destination storage subsystem, the processor 320 (volume migration management program 311) of the source storage subsystem deletes a volume identified by the received volume identification and management information of this volume from the volume management table 318. In the case where the received information indicates that the number of acquired volumes is 0, a communication-permitted group permitted to access the destination storage subsystem is deleted. Thereafter, the processor 320 of the source storage subsystem notifies the destination storage subsystem of the completion of the deletion of the volume and the management information (S414).

Receiving the completion notification about the volume and management information deletion from the source storage subsystem, the processor 320 (volume copy management program 314) of the destination storage subsystem deletes from the acquired volume management table 319 information of a volume identified by the acquired volume identification that has been processed. At the time this delete procession is finished, the processor 320 (volume copy management program 314) of the destination storage subsystem notifies the volume acquisition management program 312 of the completion of the processing (S415).

Next, the processor 320 (volume acquisition management program 312) of the destination storage subsystem notifies the management computer 400 that the processing of the volume instructed to migrate has been completed (S417).

As has been described, according to the first embodiment of this invention, a computer system in which a plurality of storage subsystems are coupled to one another sets access limitation to a port of the source storage subsystem when a logical volume to be migrated between storage subsystems, thereby guaranteeing that the destination storage subsystem can acquire any volume recognized by the destination storage subsystem. The administrator is thus prevented from making an operational mistake.

In addition, information indicating the type of migration is transmitted to the destination storage subsystem, thereby enabling the destination storage subsystem to verify the migration type of a recognized volume. This, too, prevents an operational mistake made by the administrator. Furthermore, the destination storage subsystem can automatically execute migration processing.

### Second Embodiment

In a second embodiment, the switch device sets zoning that allows a source storage subsystem and destination storage subsystem specified by an administrator to communicate with each other. Specifically, the second embodiment uses the switch device to limit storage subsystems permitted to access a source storage subsystem, with the type of migration managed in advance on a source volume basis. At the time a destination storage subsystem recognizes a volume, whether or not the destination storage subsystem is permitted to acquire the volume is determined, which ensures that processing executed for a volume is appropriate for the volume.

A computer system of the second embodiment has the same configuration as the system configuration (illustrated in FIG. 1) described in the first embodiment. The configurations of the host computers 100, the switch device 200, and the storage subsystems 300 in the second embodiment are the same as those in the first embodiment. The management computer 400 of the second embodiment has a configuration different from the management computer described in the first embodiment. In the second embodiment, components and processing that are the same as those described in the first embodiment are denoted by the same reference symbols, and descriptions thereof are omitted.

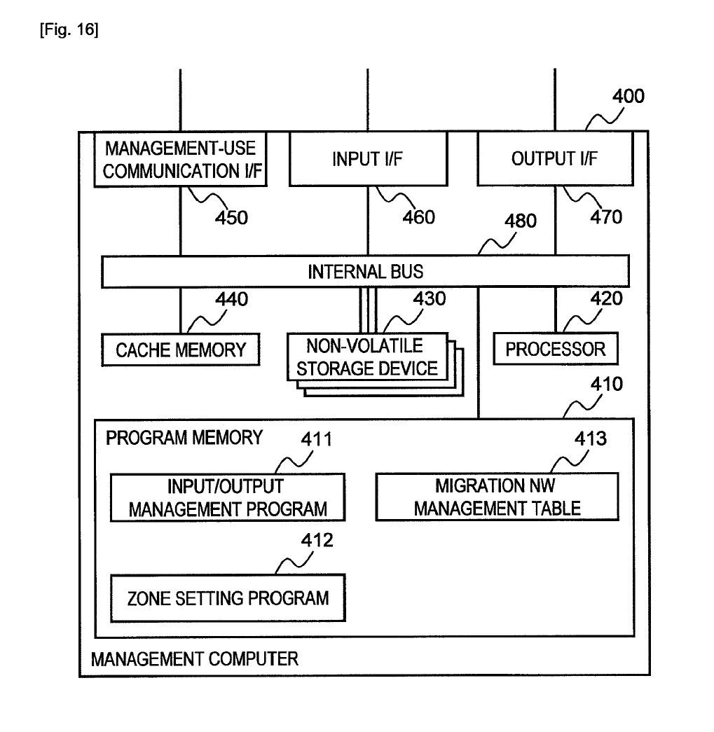

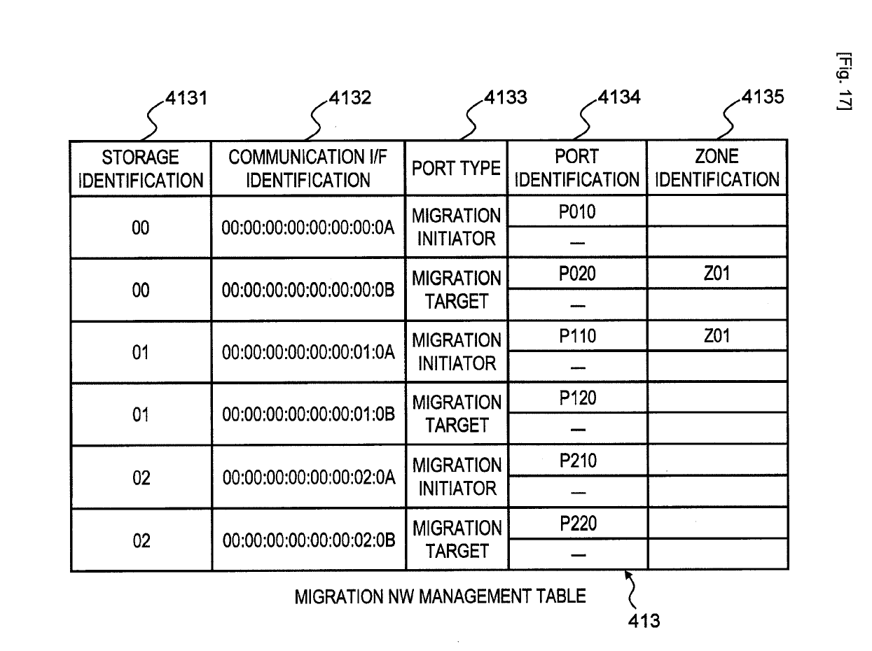

FIG. 16 is a block diagram illustrating the physical configuration and program configuration of the management computer 400 according to the second embodiment.

The management computer 400 includes a program memory 410, a processor 420, a non-volatile storage device 430, a cache memory 440, a management-use communication IF 450, an input I/F 460, and an output I/F 470. These components are connected to one another via an internal bus 480.

The program memory 410 stores, at least, the input/output management program 411, a zone setting program 412, and a migration NW management table 413.

The input/output management program 411 transfers a volume migration instruction input from the input I/F 460 by the administrator to the zone setting program 412 and one of the storage subsystems 300, receives a processing result from the storage subsystem 300, and presents the processing result to the administrator through the output I/F 470. The zone setting program 412 sets a zone in the switch device 200.

Details of the migration NW management table 413 are described later with reference to FIG. 17.

FIG. 17 is a diagram illustrating an example of the configuration of the migration NW management table 413 according to the second embodiment.

The migration NW management table 413 is a table for managing the data I/O communication I/Fs 360 of the storage subsystems 300 which are managed by the management computer 400, and contains, at least, a storage identification 4131, a communication I/F identification 4132, a port type 4133, a port identification 4134, and a zone identification 4135 in each entry.

The storage identification 4131 is a unique identification for identifying each of the storage subsystems 300 which are managed by the management computer 400.

The communication I/F identification 4132 is a unique identification for identifying the data I/O communication I/F 360 of each of the storage subsystems 300 which are managed by the management computer 400.

The port type 4133 is information for managing the use of a port and, similarly to the port type 3153 of the communication I/F management table 315 described in the first embodiment, has values defined in the SCSI standards.

The port identification 4134 is a unique identification for identifying a port that is allocated to one of the data I/O communication I/Fs 360 connected to the volume migration network 600.

The zone identification 4135 is a unique identification for identifying a zone set in the switch device 200.

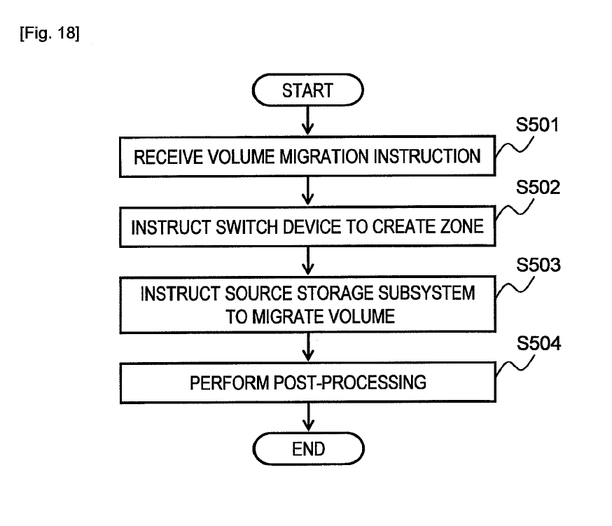

FIG. 18 is a flow chart of zone setting processing according to the second embodiment. The zone setting processing is executed by the processor 420 of the management computer 400 by executing the zone setting program 412.

The processor 420 receives from the input/output management program 411 a volume migration instruction input to the input I/F 460 by the administrator (S501). As in the first embodiment described above, the volume migration instruction contains, at least, the identification of the source volume, the identification of the destination storage subsystem, and a migration type.

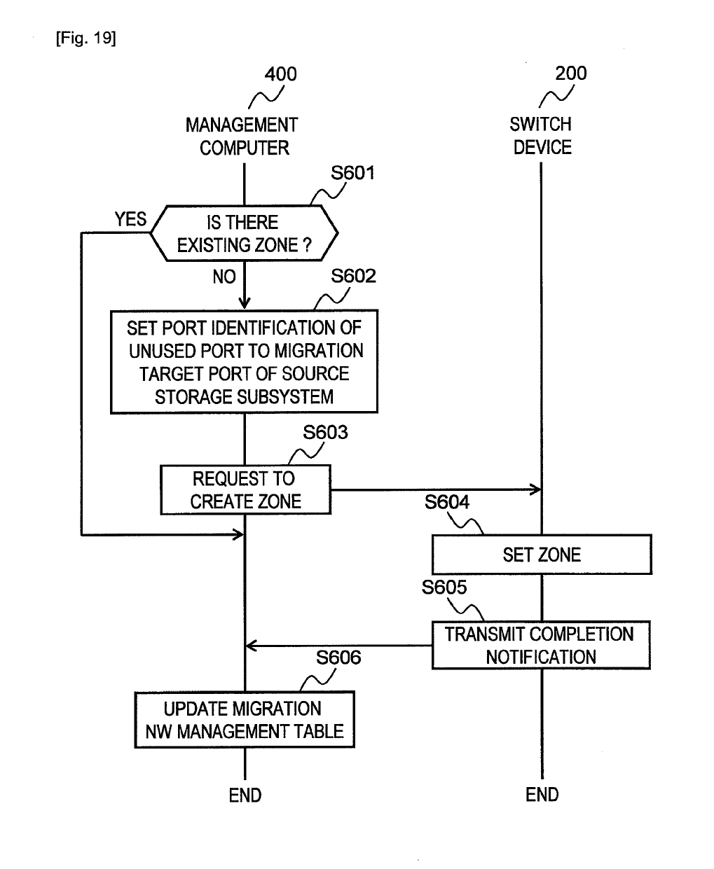

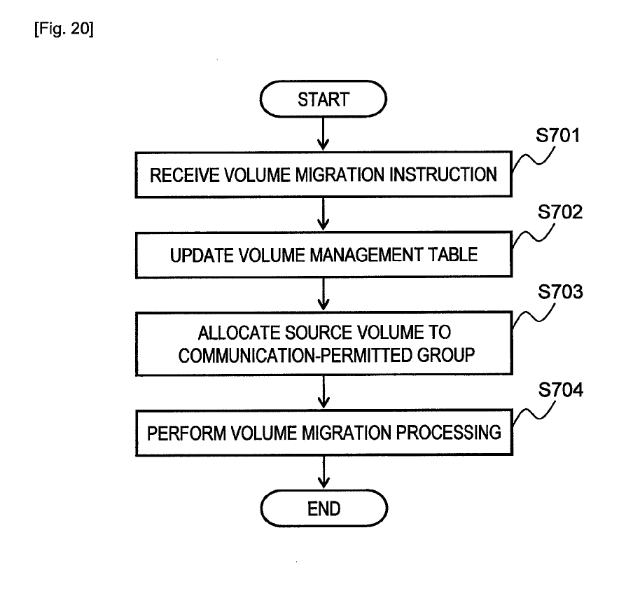

The processor 420 next issues an instruction to the switch device 200 to create a zone that permits communication between the destination storage subsystem and the source storage subsystem (S502). Details of Step S502 are described later with reference to FIG. 19.

The processor 420 next instructs the source storage subsystem 300 to migrate the volume. This volume migration instruction contains the identification of the source volume, the port identification of a migration target port to which a zone containing the destination storage subsystem is set, and a migration type (S503).

The processor 420 then executes post-processing (S504). Details of Step S504 are described later with reference to FIG. 20.

FIG. 19 is a sequence diagram illustrating details of Step S502 of the zone setting processing and corresponding processing of the switch device 200 according to the second embodiment. The sequence of FIG. 19 is executed through the execution of the zone setting program 412 by the processor 420 of the management computer 400 and the execution of the zone management program 211 by the processor 220 of the switch device 200.

The processor 420 (zone setting program 412) refers to the migration NW management table 413 to determine whether or not a zone has been set that permits communication between the destination storage subsystem and the source storage subsystem which are contained in the migration instruction input by the administrator (S601). If it is found as a result that the zone has not been set, the processing proceeds to Step S606. If the zone has been set, the processing proceeds to Step S602.

In Step S602, the processor 420 refers to the migration NW management table 413 to identify an unused port, and sets the port identification 4134 such that a migration target port of the source storage subsystem has the identification of the identified port.

The processor 420 next instructs the switch device 200 to create a zone (S603). The zone creating instruction contains, at least, the port identification 4134 of a migration initiator port of the destination storage subsystem and the port identification of the migration target port of the source storage subsystem that has been set in Step S602.

When the switch device 200 receives the zone creating instruction from the management computer 400, the processor 220 (zone management program 211) updates the zone management table 212 to set a zone that permits communication between the ports specified in the zone creating instruction (S604).

The processor 220 (zone management program 211) then notifies the management computer 400 of the completion of the zone creation (S605). The zone creation completion notification contains, at least, the zone identification 2121 of the zone created in Step S604.

When the management computer 400 receives the zone creation completion notification from the switch device 200, the processor 420 (zone setting program 412) stores the zone identification contained in the received zone creation completion notification as the zone identification 4135 in the migration NW management table 413, thereby updating the migration NW management table 413 (S606).

FIG. 20 is a flow chart of volume migration management processing according to the second embodiment. The volume migration management processing is executed by the processor 320 of the source storage subsystem 300 by executing the volume migration management program 311.

As described above, the management computer 400 instructs the source storage subsystem 300 to migrate the volume in Step S503 of the zone setting processing. The processor 320 (volume migration management program 311) of the source storage subsystem 300 receives the volume migration instruction from the input/output management program 411 of the management computer 400 (S701). The volume migration instruction contains, at least, the identification of a port allocated to the relevant data I/O communication I/F, the identification of the source volume, and a migration type.

The processor 320 next stores the migration type of the source volume which is contained in the received volume migration instruction as the migration type 3183 in the volume management table 318, thereby updating the volume management table 318 (S702).

The processor 320 next allocates the source volume to a communication-permitted group and sets the allocation in the volume management table 318 (S703). In the second embodiment, no particular communication-permitted group is set, and the volume is therefore allocated to a communication-permitted group in which communication between arbitrary ports is permitted.

The processor 320 then processes requests from the destination storage subsystem and executes volume migration processing (S704).

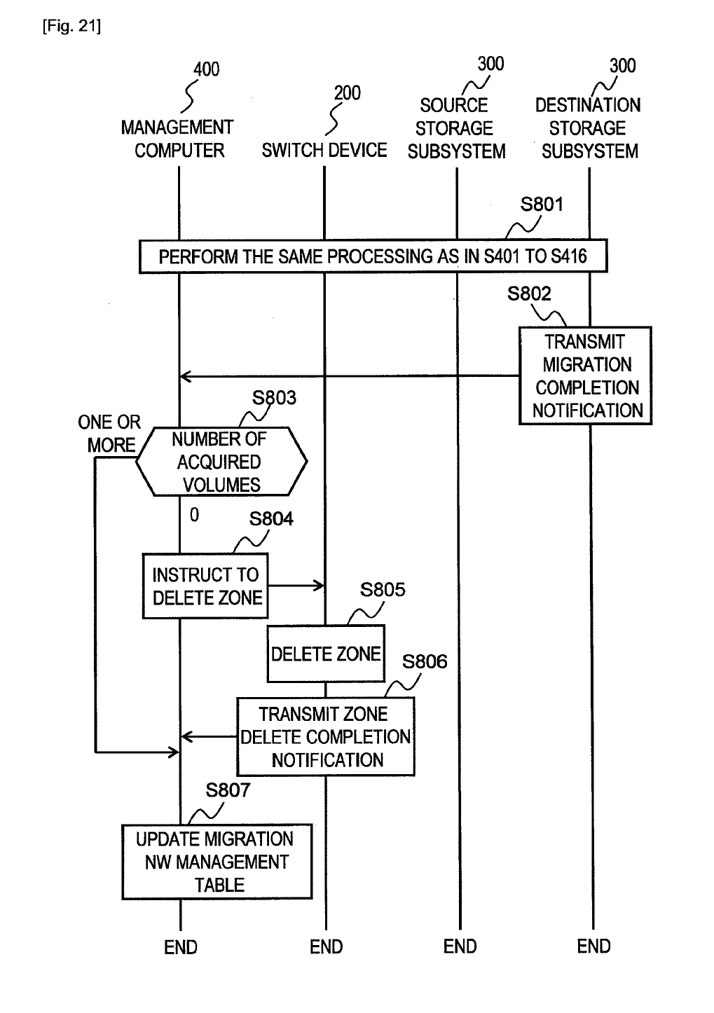

FIG. 21 is a sequence diagram illustrating details of Step S704 of the volume migration management processing and corresponding processing of the destination storage subsystem 300 according to the second embodiment. The sequence of FIG. 21 is executed through the execution of the zone setting program 412 by the processor 420 of the management computer 400 and the execution of the volume acquisition management program 312 by the processor 320 of the destination storage subsystem.

First, the processor 320 (volume migration management program 311) of the source storage subsystem and the processor 320 (volume acquisition management program 312) of the destination storage subsystem execute the same processing as in Steps S401 to S416 of the volume migration processing of the first embodiment which are illustrated in FIGS. 15A and 15B (S801).

Next, the processor 320 (volume acquisition management program 312) of the destination storage subsystem notifies the management computer 400 that the processing of the volume instructed to migrate has been completed (S802). The migration completion notification contains the number of volumes recognized by the destination storage subsystem. The number of the recognized volumes can be calculated by referring to the acquired volume management table 319.

When the management computer 400 receives the volume migration completion notification, the processor 420 (zone setting program 412) verifies the number of acquired volumes which is contained in the received volume migration completion notification (S803).

If it is found as a result that the number of acquired volumes is 1 or larger, the processing proceeds to Step S807. If the number of acquired volumes is 0, on the other hand, the processor 420 (zone setting program 412) of the management computer 400 instructs the switch device 200 to delete a zone that permits communication between the destination storage subsystem and the source storage subsystem (S804). The zone delete instruction contains the zone identification 2121 of a zone that permits communication between the destination storage subsystem and the source storage subsystem.

When the switch device 200 receives the zone delete instruction, the processor 220 (zone management program 211) deletes the zone identification contained in the received zone delete instruction from the zone management table 212, thereby updating the zone management table 212 (S805).

The processor 220 (zone management program 211) of the switch device 200 next notifies the management computer 400 of the completion of the zone deletion (S806).

The processor 220 (zone management program 211) of the switch device 200 then deletes from the migration NW management table 413 the port identification 4134 that has been set in Step S602 and the zone identification 4135 (S807).

As has been described, according to the second embodiment of this invention, in a computer system in which a plurality of storage subsystems are coupled to one another, the switch device 200 sets the zoning when a logical volume is to be migrated between storage subsystems, thereby guaranteeing that the destination storage subsystem can acquire any volume recognized by the destination storage subsystem. The administrator is thus prevented from making an operational mistake.

### Third Embodiment

A third embodiment is described next. While the first embodiment described above uses settings that are set to a port of a source storage subsystem to control the access of other storage subsystems to a source volume, the third embodiment uses settings that are set to a port of a destination storage subsystem to control the access of other storage subsystems to a source volume.

A computer system of the third embodiment has the same configuration as the system configuration (illustrated in FIG. 1) described in the first embodiment. The configurations of the host computers 100, the switch device 200, the storage subsystems 300, and the management computer 400 in the third embodiment are the same as those in the first embodiment. The specifics of the processing of programs and the contents of tables in the third embodiment are the same as those in the first embodiment, except ones specially described below.

In the third embodiment, components and processing that are the same as those described in the first embodiment are denoted by the same reference symbols, and descriptions thereof are omitted.

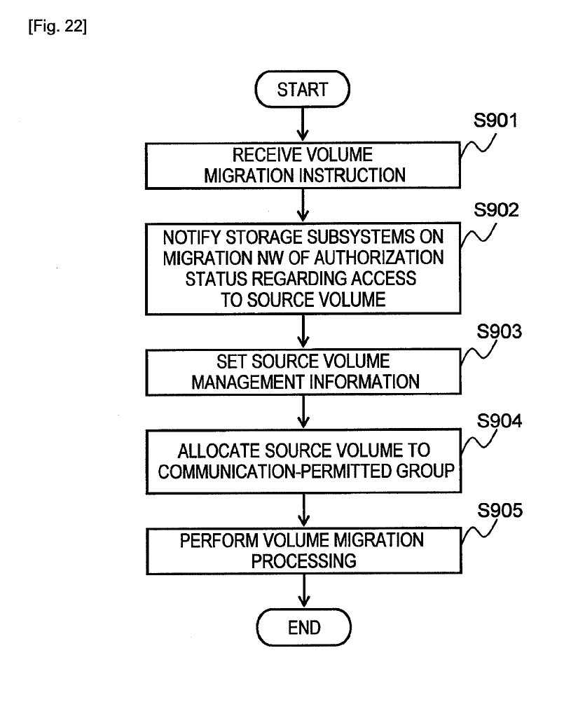

FIG. 22 is a flow chart of volume migration management processing according to the third embodiment. The volume migration management processing is executed by the processor 320 of the source storage subsystem 300 by executing the volume migration management program 311.

As described above, the management computer 400 issues the volume migration instruction to the source storage subsystem 300 in Step S503 of the zone setting processing. The processor 320 (volume migration management program 311) of the source storage subsystem 300 receives the volume migration instruction from the input/output management program 411 of the management computer 400 (S901). The volume migration instruction contains, at least, the identification of a source logical volume, the identification of the destination volume, and a migration type.

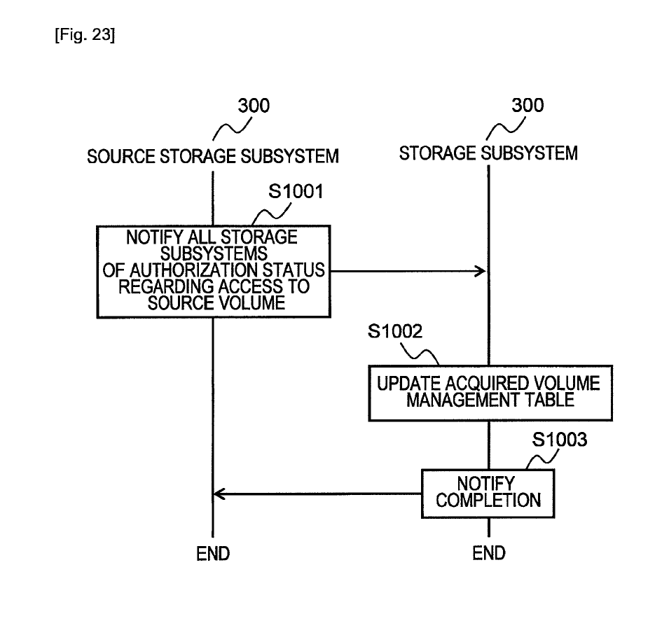

The processor 320 next notifies all of the storage subsystems 300 on the volume migration network 600 of their authorization status regarding access to the source volume (S902). Details of Step S902 are described later with reference to FIG. 23.

The processor 320 next stores the migration type of the source volume which is contained in the received volume migration instruction as the migration type 3183 in the volume management table 318, thereby updating the volume management table 318 (S903).

The processor 320 next allocates the logical volume specified by the management computer 400 to a communication-permitted group that is permitted to communicate with the destination storage subsystem, and sets the allocation in the volume management table 318 (S904). Specifically, the logical volume is allocated to a communication-permitted group in which communication between arbitrary storage subsystems is permitted. Details of Step S904 are the same as the processing of allocating a volume to a communication-permitted (permitted/prohibited) group (illustrated in FIG. 14) that is described in the first embodiment.

The processor 320 next grants the destination storage subsystem access and executes volume migration processing (S905). Details of Step S905 are the same as the volume migration processing (illustrated in FIGS. 15A and 15B) described in the first embodiment.

The processor 320 (volume acquisition management program 312) of the destination storage subsystem 300 executes the same volume acquisition processing as that of FIGS. 15A and 15B.

FIG. 23 is a sequence diagram illustrating the access authorization status notifying processing (S902) and corresponding processing of the other storage subsystems 300 than the source storage subsystem 300 according to the third embodiment.

First, the processor 320 (volume migration management program 311) of the source storage subsystem 300 notifies all of the storage subsystems 300 connected to the volume migration network 600 of their authorization status regarding access to the source volume (S1001). Specifically, “access granted” is notified to the storage subsystem 300 that is specified as the migration destination by the administrator, and “access denied” is notified to the rest of the other storage subsystems 300 than the source storage subsystem 300. The notification contains, at least, the identification of the source volume and the port identification of a migration target port of the source storage subsystem 300.

The other storage subsystems 300 than the source storage subsystem 300 use the received notifications to update the acquired volume identification 3191, recognized port identification 3192, volume identification 3193, and accessibility 3196 of their respective acquired volume management tables 319 (S1002).

The other storage subsystems 300 than the source storage subsystem 300 then notify the source storage subsystem 300 of the table update (S1003).

As has been described, according to the third embodiment of this invention, a computer system in which a plurality of storage subsystems are coupled to one another sets access limitation to a port of the destination storage subsystem when a logical volume is to be migrated between storage subsystems, thereby guaranteeing that the destination storage subsystem can acquire any volume recognized by the destination storage subsystem. The administrator is thus prevented from making an operational mistake.

### Fourth Embodiment

A fourth embodiment is described next. While the second embodiment described above uses the management computer to set in the switch device settings that control the access of other storage subsystems to a source volume, the fourth embodiment uses a storage subsystem to set in the switch device settings that control the access of other storage subsystems to a source volume.

A computer system of the fourth embodiment has the same configuration as the system configuration (illustrated in FIG. 1) described in the first and second embodiments. The configurations of the host computers 100, the switch device 200, the storage subsystems 300, and the management computer 400 in the fourth embodiment are the same as those in the first and second embodiments. The specifics of the processing of programs and the contents of tables in the fourth embodiment are the same as those in the first and second embodiments, except ones specially described below.

In the fourth embodiment, components and processing that are the same as those described in the first and second embodiments are denoted by the same reference symbols, and descriptions thereof are omitted.

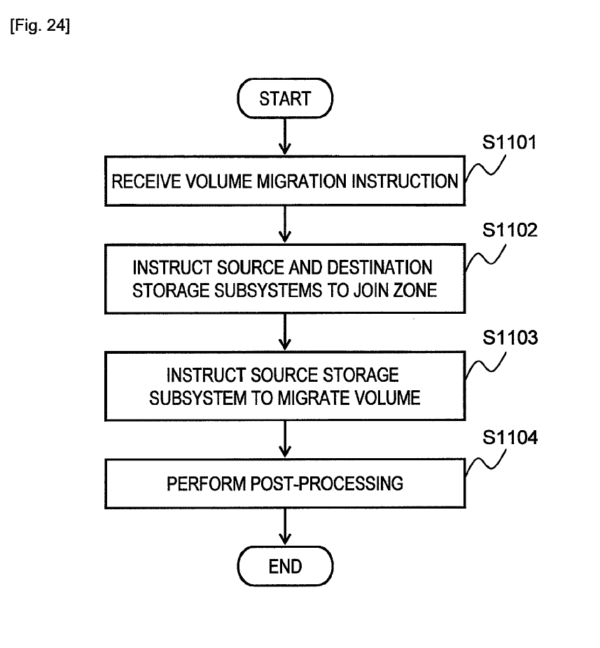

FIG. 24 is a flow chart of zone setting processing according to the fourth embodiment. The zone setting processing is executed by the processor 420 of the management computer 400 by executing the zone setting program 412.

The processor 420 first receives a volume migration instruction input by the administrator (S1101). The volume migration instruction is input to the input/output management program 411 by the administrator, and contains the same information as in the first embodiment.

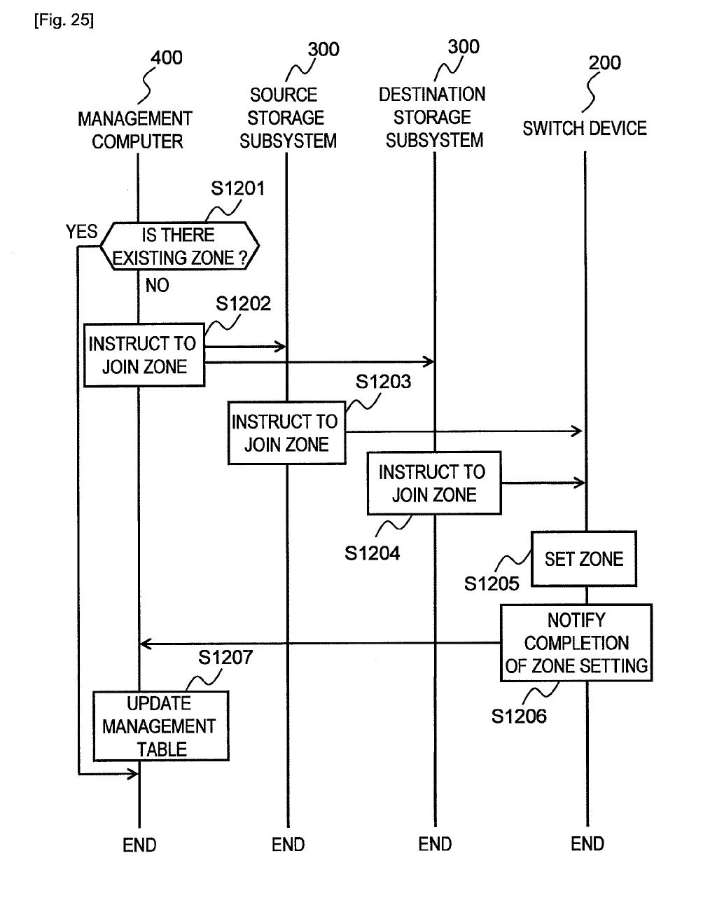

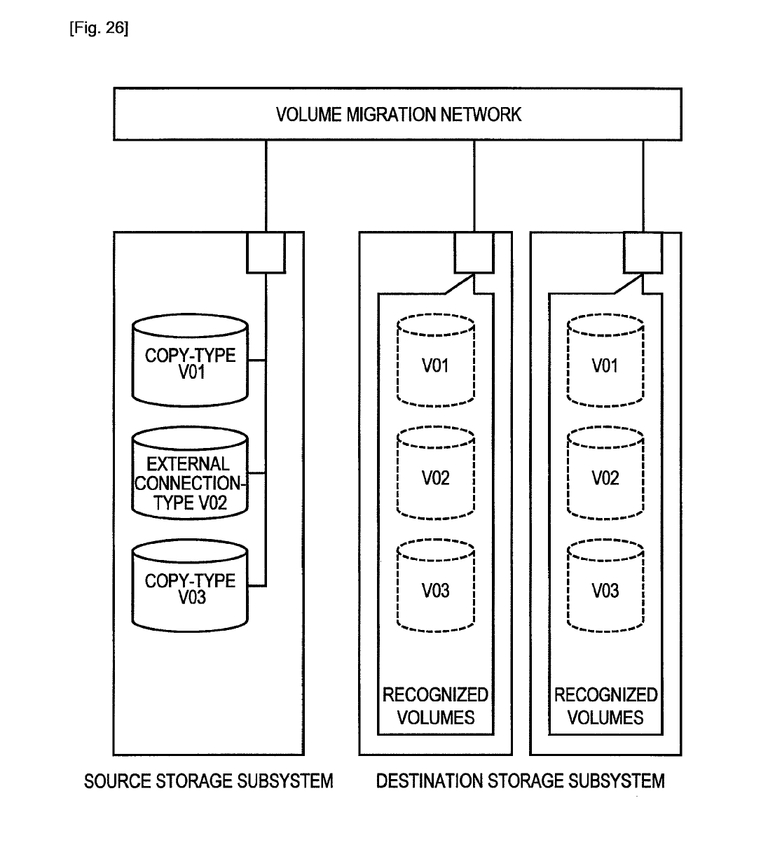

The processor 420 next instructs the source storage subsystem and the destination storage subsystem to join the same zone (S1102). Details of Step S1102 are described later with reference to FIG. 25.

The processor 420 next instructs the source storage subsystem to migrate the volume (S1103). The volume migration instruction contains the identification of the source volume, the identification of a migration target port, and a port type.

The processor 420 then executes post-processing (S1104). Details of Step S504 are the same as the post-processing (illustrated in FIG. 20) described in the second embodiment.

FIG. 25 is a sequence diagram illustrating Step S1102 of the zone setting processing and corresponding processing of the source storage subsystem 300, the destination storage subsystem 300, and the switch device 200 according to the fourth embodiment.

The sequence of FIG. 25 is executed through the execution of the zone setting program 412 by the processor 420 of the management computer, the execution of the volume migration management program 311 by the processor 320 of the source storage subsystem, the execution of the volume migration management program 311 by the processor 320 of the destination storage subsystem, and the execution of the zone management program 211 by the processor 220 of the switch device 200.

The processor 420 of the management computer 400 refers to the migration NW management table 413 to verify whether or not a zone that permits communication between a source storage subsystem and a destination storage subsystem specified by the administrator has been set (S1201). When it is found as a result that there is no zone that permits communication between the source storage subsystem and the destination storage subsystem, the processing proceeds to Step S1202. When there is a zone that permits communication between the source storage subsystem and the destination storage subsystem, on the other hand, the processor 420 terminates Step S1102, and the processing proceeds to Step S1103.

In Step S1202, the processor 420 of the management computer 400 instructs the source storage subsystem and the destination storage subsystem to let their migration ports join the same zone (S1202). The “join zone” instruction contains, at least, the zone identification 4135 of the migration NW management table 413 that identifies an arbitrary unused zone.

Next, the processor 320 of the source storage subsystem 300 transmits the identification of the migration target port and the zone identification, which has been received from the management computer 400, to the switch device 200, and instructs the switch device 200 to let the migration target port of the source storage subsystem join the same zone as that of the migration initiator port of the destination storage subsystem (S1203).

Next, the processor 320 of the destination storage subsystem 300 transmits the port identification of the migration initiator port and the zone identification, which has been received from the management computer 400, to the switch device 200, and instructs the switch device 200 to let the migration initiator port of the destination storage subsystem join the same zone as that of the migration target port of the source storage subsystem (S1204).

The processor 220 of the switch device 200 uses the port identifications contained in the “join zone” instructions to associate the received “join zone” instructions with each other. Specifically, when there are “join zone” instructions containing the same zone identification, the processor 220 sets a zone by associating port identifications that are specified in these “join zone” instructions with each other (S1205).

The processor 220 of the switch device 200 next notifies the management computer 400 of the completion of the zone setting (S1206). The zone setting completion notification contains, at least, the identification of the set zone.

The processor 420 of the management computer 400 updates the migration NW management table 413 based on the received zone setting completion notification (S1207).

As has been described above, according to the fourth embodiment of this invention, a computer system in which a plurality of storage subsystems are coupled to one another allows two of the storage subsystems between which a logical volume is to be migrated to set zoning in the switch device, thereby guaranteeing that the destination storage subsystem can acquire any volume recognized by the destination storage subsystem. The administrator is thus prevented from making an operational mistake.

While the present invention has been described in detail and pictorially in the accompanying drawings, the present invention is not limited to such detail but covers various obvious modifications and equivalent arrangements, which fall within the purview of the appended claims.

Other aspects of this invention disclosed herein that are not included in the scope of claims are as follows:

(1) A storage subsystem connected to another storage subsystem via a switch device, including:

a storage device which provides a volume for storing data;

a processor which executes a program for controlling the storage subsystem;

a memory which stores data used by the processor; and

a port which is coupled to the another storage subsystem,

in which the memory stores interface management information, which holds a use of the port in migration, and port management information, which holds a use of a port of the another storage subsystem in migration, and

in which the processor is configured to:

refer to the interface management information and the port management information to identify a port of the another storage subsystem which is permitted to communicate with the port of the storage subsystem in order to determine a communication zone of the port coupled to the another storage subsystem for migration; and

transmit a request to set the determined port communication zone in the switch device.

(2) A storage subsystem, including:

a storage device which provides a volume for storing data;

a processor which executes a program for controlling of the storage subsystem;

a memory which stores data used by the processor; and

a port which is connected to another storage subsystem,

in which the processor is configured to:

transmit, to the another storage subsystem, a request for a type of a volume that is coupled to the port for which the communication zone has been determined; and

refer to volume management information, and transmit in response a type of migration that is set to the volume of the request in a case of reception of the request for the type of the volume that is connected to the port.

1. A storage subsystem, comprising:
a storage device which provides a volume for storing data;
a processor which executes a program for controlling the storage subsystem;
a memory which stores data used by the processor; and
a port which is coupled to another storage subsystem,
wherein the memory stores interface management information, which holds a use of the port in migration, and port management information, which holds a use of a port of the another storage subsystem in migration, and
wherein the processor is configured to refer to the interface management information and the port management information to identify a port of the another storage subsystem which is permitted to communicate with the port of the storage subsystem, thereby determining a communication zone of the port coupled to the another storage subsystem for migration.

2. The storage subsystem according to claim 1,
wherein the memory stores acquired volume management information, which holds a type of migration of the volume that can be acquired from the another storage subsystem via the port, and wherein the processor is configured to:
refer to the port management information, and identify a port of the another storage subsystem which is permitted to communicate with the port of the storage subsystem;
obtain, from the another storage subsystem via the identified port, information about a volume of the another storage subsystem that is permitted to communicate with the identified port and information about a migration type set to the volume;
store the obtained information in the acquired volume management information;
obtain a capacity of the volume identified by the obtained information about the volume from the another storage subsystem in a case where the obtained information about the migration type is “copy”;
create a volume having a capacity equal to the obtained capacity;
copy data stored in the identified volume to the created volume; and
delete the obtained information about the volume from the acquired volume management information after the copying is completed.

3. The storage subsystem according to claim 1,
wherein the storage subsystem is coupled to the another storage subsystem via a switch device, and
wherein the processor is configured to transmit a request to set the determined communication zone in the switch device.

4. The storage subsystem according to claim 3,
wherein the storage subsystem is coupled to the management computer for managing the storage subsystem, and
wherein the processor is configured to transmit, to the switch device, an identification of the port and a communication zone identification,
which is received from the management computer in a case of reception of an instruction to cause the port to join the communication zone from the management computer.

5. The storage subsystem according to claim 1, wherein the memory stores volume management information, which holds a type of migration of the volume, and
wherein the processor is configured to refer to the volume management information and, transmit in response a type of migration that is set to the volume of the request in a case of reception of a request for a type of a volume that is coupled to the port.

6. The storage subsystem according to claim 5, wherein the processor is configured to transmit, to the another storage subsystem, a request for a type of a volume that is coupled to the port for which the communication zone has been determined.

7. The storage subsystem according to claim 6, wherein the processor is configured to execute migration processing suited to the migration type of the volume in a case of reception of a request for the migration.

8. A data migration method for migrating data executed in a computer system between the first storage subsystem and the second storage subsystem, the computer system including at least a first storage subsystem and a second storage subsystem,
the first storage subsystem and the second storage subsystem each including a storage device which provides a volume for storing data, a processor which executes a program for controlling the storage subsystem, a memory which stores data used by the processor, and a port which is coupled to another storage subsystem,
the memory of each of the first storage subsystem and the second storage subsystem storing interface management information, which holds a use of the port in migration, and port management information, which holds a use of a port of the another storage subsystem in migration,
the method including the steps of:
identifying, by the first storage subsystem, a port of the second storage subsystem which is permitted to communicate with a port of the first storage subsystem through reference to the interface management information and the port management information; and
determining, by the first storage subsystem, a communication zone of a port of the first storage subsystem that is coupled via the identified port to the second storage subsystem for migration, based on the identified port of the second storage subsystem.

9. The data migration method according to claim 8,
wherein each of the memory of the first storage subsystem and the second storage subsystem stores acquired volume management information, which holds a type of migration of the volume that can be acquired from the another storage subsystem via the port, and
wherein the method further including the steps of:
identifying, by the first storage subsystem, a port of the second storage subsystem which is permitted to communicate with a port of the first storage subsystem through reference to the port management information;
requesting, from the first storage subsystem to the second storage subsystem via the identified port, information about the volume of the second storage subsystem that is permitted to communicate with the identified port and information about a migration type set to the volume;
transmitting, from the second storage subsystem to the first storage subsystem, the requested information about the volume and the requested information about the migration type set to the volume;
storing, by the first storage subsystem, the information obtained from the second storage subsystem in the acquired volume management information of the first storage subsystem;
requesting from the first storage subsystem to the second storage subsystem so as to request a capacity of the volume identified by the obtained information about the volume in a case where the obtained information about the migration type is “copy”, and obtaining, by the first storage subsystem, the capacity of the identified volume from the second storage subsystem;
creating, by the first storage subsystem, a volume having a capacity equal to the obtained capacity;
copying, by the first storage subsystem, data stored in the identified volume to the created volume; and
deleting, by the first storage subsystem, the obtained information about the volume from the acquired volume management information of the first storage subsystem after the copying is completed.

10. The data migration method according to claim 8,
wherein the first storage subsystem is coupled to the second storage subsystem via a switch device, and
wherein the first storage subsystem, a request to set the determined port communication zone in the switch device.

11. The data migration method according to claim 10,
wherein the computer system further includes a management computer, which manages the first storage subsystem and the second storage subsystem, and
wherein the method further including the step of transmitting, by the first storage subsystem, to the switch device, an identification of the port of the first storage subsystem and a communication zone identification, which is received from the management computer, in a case of reception of an instruction to cause a port of the first storage subsystem to join the communication zone from the management computer.

12. The data migration method according to claim 8,
wherein the memory of each of the first storage subsystem and the second storage subsystem stores volume management information, which holds a type of migration of the volume, and
wherein the method further including the step of referring, by the first storage subsystem, to the volume management information and transmitting, by the first storage subsystem, in response a migration type that is set to the volume of the request in a case of reception of a request for a type of a volume that is coupled to a port of the first storage subsystem.

13. The data migration method according to claim 12, wherein the method further including the steps of
transmitting, by the first storage subsystem, to the second storage subsystem, a request for a type of a volume that is coupled to a port for which the communication zone has been determined, and executing, by the first storage subsystem, migration processing suited to the migration type of the volume in a case of reception of a request for the migration.

14. A computer system, comprising:
a first storage subsystem;
a second storage subsystem:
a management computer which manages the first storage subsystem and the second storage subsystem; and
a switch device which couples the first storage subsystem and the second storage subsystem,
wherein the first storage subsystem and the second storage subsystem each includes: a storage device which provides a volume for storing data; a processor which executes a program for controlling the storage subsystem; and a port which is coupled to the another storage subsystem,
wherein the management computer includes a memory storing network management information, which holds uses of a port of the first storage subsystem and a port of the second storage subsystem in migration,
wherein the management computer is configured to:
refer to the network management information to determine a communication zone of ports coupled to the first storage subsystem and the second storage subsystem for migration; and
give an instruction about the determined communication zone to the switch device, and
wherein the switch device sets a communication zone that permits communication between the first storage subsystem and the second storage subsystem based on the instruction.

15. The computer system according to claim 14, wherein the management computer is configured to:
refer to the network management information to retrieve an unused port of the second storage subsystem; and
determine the port communication zone in a manner that allows communication between the retrieved unused port and a migration port of the first storage subsystem.
